(19) United States
(12) Patent Application Publication
(10) Pub. No.: US 2013/0196655 A1
(43) Pub. Date: Aug. 1, 2013

(54) METHOD AND SYSTEM FOR DYNAMIC PROVISIONING WHILE ROAMING

(71) Applicants: Bohdan K. Zabawskyj, Woodbridge (CA); Rushabhdev Gudka, Scarborough (CA)

(72) Inventors: Bohdan K. Zabawskyj, Woodbridge (CA); Rushabhdev Gudka, Scarborough (CA)

(73) Assignee: REDKNEE INC., Mississauga, ON (CA)

(21) Appl. No.: 13/808,937

(22) PCT Filed: Jul. 8, 2010
(86) PCT No.: PCT/CA2010/001049

§ 371 Date: Mar. 25, 2013

(51) Int. Cl. H04W 8/18

(52) U.S. Cl. CPC H04W 8/18
USPC 455/432.3

(57) ABSTRACT

A method, system and apparatus for dynamic provisioning while roaming is provide. Aspects of the specification comprise a home carrier infrastructure and a roaming carrier infrastructure that are configured to provide access to a binding network from a mobile computing device that is associated with said home carrier infrastructure. In one aspect the home carrier infrastructure comprises a roaming provisioning server configured to dynamically determine a possible roaming service profile or billing profile that may be established in response to a request from said mobile computing device to access said roaming carrier infrastructure.

### FIELD

The present specification relates generally to telecommunications and more particularly relates to a method and system for dynamic provisioning while roaming.

### BACKGROUND

Mobile computing devices rely on access to different wireless base stations in order to connect with different communication networks. Mobile computing devices are also typically associated with a home carrier that provides a plurality of different wireless base stations. However, frequently and increasingly mobile computing devices are activated outside the operating area of their home carrier, requiring those mobile computing devices to roam and attain network access through carriers other than their home carrier.

### SUMMARY

A method, system and apparatus for dynamic provisioning while roaming is provide. Aspects of the specification comprise a home carrier infrastructure and a roaming carrier infrastructure that are configured to provide access to a binding network from a mobile computing device that is associated with said home carrier infrastructure. In one aspect the home carrier infrastructure comprises a roaming provisioning server configured to dynamically determine a possible roaming service profile or billing profile that may be established in response to a request from said mobile computing device to access said roaming carrier infrastructure.

### BRIEF DESCRIPTION OF THE DRAWINGS

FIG. 1 shows a schematic representation of a system for dynamic provisioning while roaming.

FIG. 2 shows the system of FIG. 1 wherein the mobile computing device of FIG. 1 is roaming.

FIG. 3 shows a flow-chart depicting a method for dynamic provisioning while roaming.

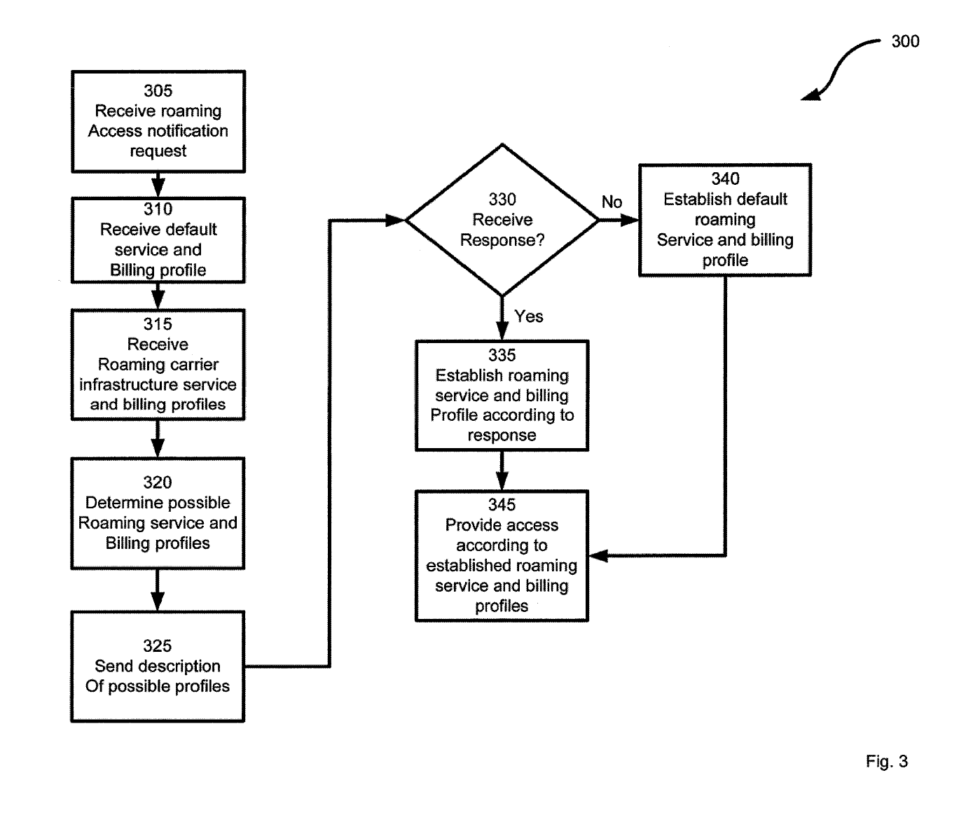

### DETAILED DESCRIPTION OF THE EMBODIMENTS

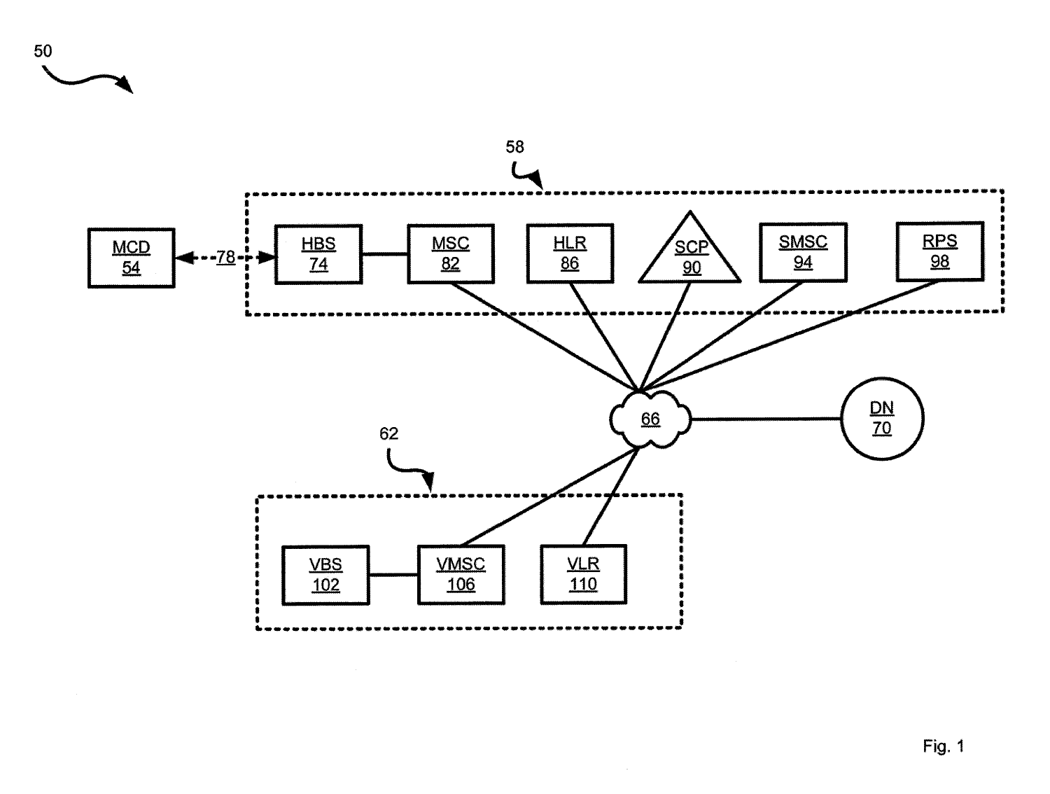

It is to be understood that the embodiments discussed herein are non-limiting examples of certain implementations. Variations on those examples are contemplated. Referring now to FIG. 1, a system for dynamic provisioning while roaming is indicated generally at 50. In a present embodiment, system 50 comprises a mobile computing device 54 that is provisioned by a home carrier infrastructure 58.

Mobile computing device 54 comprises a computing environment that provides mobile communications such as a cellular telephone or enhanced versions thereof or the like. System 50 also comprises a roaming carrier infrastructure 62, which mobile computing device 54 can use to gain roaming access. System 50 also comprises a binding network 66 and a destination node 70. Destination node 70 can comprise any type of electronic device with which mobile computing device 54 may effect communications through the intermediation infrastructures shown in system 50. For example, destination node 70 may be a web server that hosts web pages, a media server that hosts audio or video content, an applications server that hosts an application such as Facebook, Google Maps, or the like, or destination node 70 may be another mobile computing device which can conduct voice or data communications. Other examples of destination node 70 will now occur to those skilled in the art.

Home carrier infrastructure 58 comprises any telecommunication infrastructure that can be used to provision access for mobile computing device 54 to binding network 66, and therefore facilitate communications between destination node 70 and mobile computing device 54. Accordingly, at least one wireless base station 74 interconnects computing device 54 and a communication network 62. (Base station 74 is presumed to also include a base station controller). In a non-limiting but present illustrative example, home carrier infrastructure 58 is based on a core mobile network infrastructure that comprises at least one home base station 74 which can be used to establish a wireless link 78 with mobile computing device 54 when mobile computing device 54 is within range of home base station 74.

Also in this illustrative example, home carrier infrastructure 58 also comprises a mobile switching centre (MSC) 78 that interconnects home base station 74 and binding network 66, thereby providing the pathway for payload communications between binding network 66 and mobile computing device 54. (As used herein, the term payload communications refers to any electronic data, such as voice, text, audio, video, that would be carried between mobile communication device 54 and destination node 70.) Those skilled in the art will now recognize that a typical home carrier infrastructure comprises a plurality of home base stations 74 and MSCs 82 which can provide such a payload communication pathway between mobile computing device 54 and binding network 66, but that only one of each is shown herein for purposes of simplifying explanation.

Also in this illustrative example, home carrier infrastructure 58 comprises at least one home location register (HLR) 86 and a service control point (SCP) 90 that are able to communicate with mobile switch centre 82 via binding network 66. HLR 86 and SCP 90 are configured for administrative functions in relation to mobile communication device 54. Accordingly, when mobile computing device 54 connects to home base station 74, certain administrative communications (as opposed to payload communications) are effected between MSC 82, HLR 86 and SCP 90 in order to ascertain and establish permissions for the access to binding network 66 by mobile communication device 54. In particular, HLR 86 hold current details about mobile communication device 54, such as, by way of non-limiting example the service(s) required by mobile communication device 54, encryption codes for that device. By the same token SCP 90 holds billing details about mobile communication device 54, including whether mobile communication device 54 is a pre-paid or post-paid device, current balance levels, and incrementing or decrementing balance levels based on usage of mobile communication device 54 and payments associated therewith. Those skilled in the art will now recognize that in variations or more generalized abstractions of home carrier infrastructure 58, HLR 86 can be implemented as a profile server, while SCP 90 can be implemented as a billing server.

Those skilled in the art will recognize that the service profile may be stored in a variety of network elements including the HLR 86 or Home Subscriber Server (HSS) (not shown) or another database or data warehouse resident in the network operator's operational support system (OSS) or business support system (BSS) including the Subscription Profile Repository (SPR) (not shown). Those skilled in the art will recognize that the billing profile may be stored in a variety of network elements including the Offline Charging System (OFCS) (not shown), Online Charging System (OCS) (not shown), or Policy and Charging Rules Function (PCRF) (not shown) as generally described in 3GPP TS 23.203 3rd Generation Partnership Project; Technical Specification Group Services and System Aspects; Policy and charging control architecture—as amended from time to time. The service profile and billing profile may also be accessed via a profile server implemented according to the teachings of U.S. patent application Ser. No. 11/516,308 entitled Method And System For Active Profile Server filed Sep. 6, 2006, the contents of which are incorporated herein by reference.

Home carrier infrastructure 98 additionally comprises a short message service centre (SMSC) 94 which can be used to deliver short message service (SMS) messages to or from mobile computing device 54 and any other device within system 50 that is configured to be able to send or receive SMS messages.

Additionally, home carrier infrastructure 58 comprises a roaming provisioning server 98, the details of which will be discussed further below.

Home carrier infrastructure 58 can also comprise other network elements, or variations on the elements shown herein, as desired in order to provide mobile computing device 54 access to binding network 66. Those skilled in the art will recognize that other network elements may comprise or coexist within the home carrier infrastructure 58 or romaing carrier infrastructure 62 without diminishing the intent and scope of the disclosure including the network elements described in 3GPP TS 23.203 3rd Generation Partnership Project; Technical Specification Group Services and Systems Aspects; Network Architecture, as amended from time to time. By way of example, a communications pathway can also be formed via a Serving GPRS Support Node (SGSN) and Gateway GPRS Support Node (GGSN) or via a Serving Gateway (S GW) and Packet Data Network Gateway (PDN GW) for data related traffic and services.

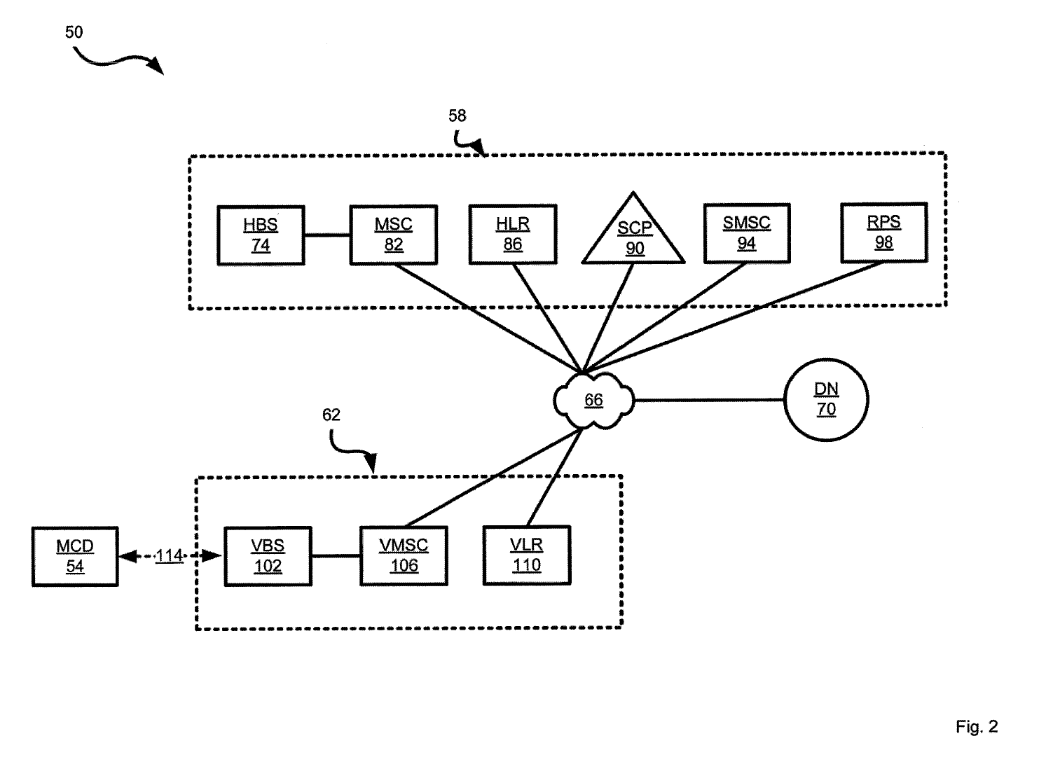

To reiterate, in this illustrative example, mobile computing device 54 is associated with home carrier infrastructure 98 so that home carrier infrastructure 98 is considered the “home” network of mobile computing device 54. Thus, HLR 86 and SCP 90 maintain the home provisioning and billing profiles for mobile computing device 54. Accordingly, and referring now to FIG. 2, roaming carrier infrastructure 62 provides mobile computing device 54 with “roaming” access to binding network 66 via wireless link 114. Roaming carrier infrastructure 82 thus comprises a visitor base station 102, a visiting mobile switching center (VMSC) 106, and a visiting location register (VLR) 110. Visitor base station 102 thus has a structure that is functionally equivalent to home base station 74 and VMSC 106 has a structure that is functionally equivalent to MSC 82. VLR 110 provides a complementary function to HLR 86, temporarily establishing a local profile for mobile computing device 54 when same is connected to visiting base station 102, but accessing HLR 86 as needed for establishing profile information. The VMSC 106 or other serving network element in the roaming carrier infrastructure 62, will forward usage information to the applicable element in the operational support system or business support system in the home carrier infrastructure 58 so that appropriate rating and/or billing can be effected. With reference to FIG. 2, this would include the SCP 90. Accordingly, mobile computing device 54 can access destination node 70 via home carrier infrastructure 58 or via roaming carrier infrastructure 62.

It should now be understood that binding network 66 may comprise any collection of networking infrastructures that complement and facilitate the functional communications described in relation to the structural components discussed in relation to system 50. For example, binding network 66 may comprise any combination of the Internet, Intranets, the public switched telephone network (PSTN), private switched telephone networks, or circuit switched or packet switched networks.

Referring now to FIG. 4, a flowchart depicting a method for dynamic provisioning while roaming is indicated generally at 300. For illustrative purposes, method 300 will be described in relation to system 50, but it is to be understood that method 300 can be performed on variations of system 50, when system 50 is in the state shown in FIG. 2 whereby mobile computing device 54 has initially accessed visiting base station 102, but mobile computing device 54 has not been provided with access to destination node 70 or any other opportunity for conducting payload communications over binding network 66. In this present example, method 300 is performed by roaming provisioning server 98.

Block 305 comprises receiving a roaming access notification request. In this example implementation, roaming provisioning server 98 receives a notification that mobile computing device 54 has sought access for payload communications to binding network 66 via roaming carrier infrastructure 62. Block 305 can be effected by roaming provisioning server 62 receiving an administrative communication from VLR 110, either directly from VLR 110 or via HLR 86, where such an administrative communication provides a unique identifier for mobile computing device 54 indicating mobile computing device 54 has sought access to binding network 66 via roaming carrier infrastructure 62. The roaming access notification request at block 305 can, if desired, be generated and sent to home carrier infrastructure 58 using existing techniques for roaming request notification techniques.

Block 310 comprises receiving a default service and billing profile. The default service profile corresponds with service profile data that is maintained by home carrier infrastructure 58 in relation to mobile computing device 54. Such service profile data may comprise, by way of a very short list of non-limiting examples, call forwarding profiles, maximum permitted data volumes and rates, a list of permitted and non-permitted services, privacy settings, and the like. The nature and scope of such service profile data is not particularly limited. When method 300 is implemented on system 50, the default service profile data may be provided by HLR 86 to roaming provisioning server 98. The default billing profile corresponds with billing profile data that is maintained by home carrier infrastructure 58 in relation to mobile computing device 54. The service profile data may also comprise historical data indicating the amount of historical access to binding network 66 by mobile computing device 54, and where such access has occurred through home carrier infrastructure 58 and where such access has occurred through roaming carrier infrastructure 62. Such billing profile data may comprise, by way of a very short list of non-limiting examples, whether mobile computing device 54 is pre-paid or post-paid, current balances, predefined billing rates and caps for different services, (e.g. voice, data, audio, video, applications, etc.), predefined billing rates and caps for accessing of those services via either home carrier infrastructure 58 or via roaming carrier infrastructure 62. When method 300 is implemented on system 50, the default billing profile data may be provided by SCP 90 to roaming provisioning server 98. The billing profile data may also comprise historical data indicating the historical financial charges to mobile communication device 54 in relation to access to binding network 66 by mobile computing device 54, and where such access has occurred through home carrier infrastructure 58 and where such access has occurred through roaming carrier infrastructure 62.

Block 315 comprises receiving roaming carrier infrastructure service and billing profiles. The roaming carrier infrastructure service profiles correspond to the actual services that roaming carrier infrastructure 62 is configured to provide. For example, where roaming carrier infrastructure 62 is a legacy Global System for Mobile Communication (GSM) that is primarily optimized for voice communications but lacks the advanced data rates offered by EDGE or 3G networks, then the roaming carrier infrastructure service profile received at block 315 indicates that the roaming carrier infrastructure is only capable of GSM voice communications. Other service profile metrics will now occur to those skilled in the art, such as maximum data rates, data capacity, and the like. In general, the service profiles referenced in block 315 represent the resources that are available in the roaming network carrier infrastructure 62. The roaming carrier infrastructure 62 billing profiles correspond to the financial charges or other in-kind exchange that the roaming carrier infrastructure charges back to the home carrier infrastructure in order to provide mobile communication device 54 with access to the roaming carrier infrastructure 62. Note that an in-kind exchange may comprise a non-financial charge, but may reflect a data or resource credit, whereby a certain amount of usage of roaming carrier infrastructure 62 by mobile communication device 54 will entitle a mobile communication device (not shown) associated with roaming carrier infrastructure 62 the opportunity to an equivalent amount of access to home carrier infrastructure 58. The roaming carrier infrastructure 62. It is therefore to be emphasized that financial charges and structuring thereof is not an essential feature of this specification.

Block 320 comprises determining possible roaming service and billing profiles. Block 320 is performed using data received at block 310 and block 315. The operations performed at block 320 may be configured to determine at least one possible roaming service and billing profile that differs from the default roaming service and billing profile for mobile computing device 54 that was ascertained at block 310. Typically, the at least one possible roaming service and billing profile establishes either a level of service that is enhanced from the default level of service from block 310, or an amount of financial charges that is reduced from the default charges from block 310, or both, that would be offered in conjunction with usage of mobile computing device 54 while mobile computing device 54 is accessing roaming carrier infrastructure 62. By the same token, the at least one possible roaming service and billing profile establishes a level of service, or an amount of financial charge, or both, that is consistent with the service and billing profiles from block 315. For example, the possible financial charges established at block 320 may be less than the default billing charges to mobile communication device 54 from block 310, but more than the default billing charges from roaming carrier infrastructure 62 from block 315. In addition to these considerations, the possible financial charges established at block 320 may be based on historical access of binding network 66 via home carrier infrastructure 58 or roaming carrier infrastructure 62 by mobile computing device 54.

As another consideration, the possible roaming service and billing profiles determined at block 320 may be based on known service and billing profiles that are offered to mobile computing devices which define carrier infrastructure 62 as their home carrier infrastructure. This consideration may be particularly germane where roaming carrier infrastructure 62 offers, for example, a short term prepaid service that provides a short term service and billing profile that provides greater service or lesser financial charges or both than the default service profile from block 310, thereby making it attractive to acquire another mobile computing device (not shown) directly associated with carrier infrastructure 62, rather than even use mobile computing device 54 in association with roaming carrier infrastructure 62.

It is also contemplated that various flat rate roaming service and billing profiles may be generated at block 320, whereby, for example different possible roaming service and billing profiles would be established based on volumes, time periods, or service types or combinations thereof. For example, a first possible roaming service and billing profile may offer unlimited SMS messages over roaming carrier infrastructure 62 for one week for a first fixed charge, while a second possible roaming service and billing profile may offer unlimited SMS messages over roaming carrier infrastructure 62 for two week period for a second fixed charge. As a non-limiting specific example, assume that the one determined possible service and billing profile is a flat fee of $10.00 for one hundred minutes of voice air time for mobile computing device 54 while mobile computing device 54 is accessing roaming carrier infrastructure 62. Other examples will now occur to those skilled in the art.

Block 325 comprises sending a description of the possible profiles determined at block 320. The means by which the description is sent is not particularly limited, and can be sent via email, voice, SMS, a wide area protocol (WAP) application or other means. In the example of system 50, roaming provisioning server 98 can effect block 325 by generating one or more SMS messages which is delivered to mobile computing device 54 via SMSC 94 or the like. The message can comprise, for example, text which reads: “Save on roaming charges. Text ‘Yes’ to 555-5555 for a one time charge of $10.00 and get 100 minutes of roaming air time.”, where 555-5555 is a destination address for SMS messages for roaming provisioning server 98.

Note that where needed, multiple SMS messages can be sent to accommodate longer messages. Such longer messages may be needed where multiple descriptions of possible roaming service and billing profiles are being sent. Also note that the description may include a number of options. For example a text based message can comprise, for example, text which reads: “Select ‘1’ for a data bundle of 50 Mb for 5 Euros, ‘2’ for a data bundle of 200 Mb for 10 Euros, or ‘3’ for unlimited data access for 24 hours for 20 Euros.”

Block 330 comprises determining whether a response has been received to the description sent at block 325. Such a response may indicate a selection or an agreement to one or more of the possible roaming service and billing profiles. Continuing with example described above, if an SMS message comprising the text “Yes” is received at roaming provisioning server from mobile computing device 54, then a “Yes” determination is made at block 325 leading method 300 to block 335. In all other circumstances, or if no “Yes” or comparable message that indicates that a selection has been made is received within a predefined time period, then a “no” determination is made at block 330 which leads to block 340. The predefined time period may be within minutes, hours or any prescribed time period. Further, even if a “no” determination is initially made at block 330, method 300 can be modified to accommodate a the arrival of the “Yes” or comparable response message is received at a later time, even if block 335 is initially reached from block 330.

Block 335 comprises establishing a roaming service and billing profile according to the response received at block 330. In the simple example, if a “Yes” determination was made that was responsive to the offer of $10.00 for 100 minutes of roaming air time, then at block 335, roaming provisioning server 98 will send instructions to HLR 86, SCP 90 or VLR 110 or any combination of them in order to put the roaming service and billing profile into effect.

Block 340, in contrast, comprises establishing a roaming service and billing profile according to the default service and billing profile from block 310. In a present embodiment, block 340 comprises no action on the part of roaming provisioning server 98, since HLR 86, SCP 90 and VLR 110 are inherently configured according to the default roaming service and billing profile.

Block 345 comprises providing access according to the established roaming service and billing profile. Block 345 contemplates the provision of payload communication access to destination node 70 or other points on binding network 66 from mobile computing device 54 via roaming carrier infrastructure 62. Such payload communication access will accord with the roaming service profile and roaming billing profiles as established at block 340.

It is to be understood that various aspects of the foregoing methods can be stored on computer-readable media that, when read by computing devices, causes those computing devices to execute according to those methods.

While certain specific embodiments have been discussed, it is to be reiterated that such embodiments are non-limiting examples and that variations, subsets and/or combinations of them are contemplated. For example, home carrier infrastructure 58 or roaming carrier infrastructure 62 may comprise different network elements than shown in accordance with the different types of possible implementations of same. Furthermore, it should be understood that home carrier infrastructure 58 and roaming carrier infrastructure 62 need not be restricted to core mobile network infrastructures, and could also be modified to accommodate WiFi infrastructures or other infrastructures that accommodate different wireless communication protocols. Furthermore, it should be understood that the method 300 can be modified. In one such modification, the possible roaming or service or both profiles are determined by network elements (such as a provisioning server) that is within the control of the roaming carrier infrastructure rather than the home carrier infrastructure 58. In addition, actual charges for the roaming access may be levied directly to a financial account (for example, a credit card number that is provided as part of the response received at block 330) associated with mobile computing device 54, rather than to SCP 90 or other billing server within home carrier infrastructure 58. The scope of the monopoly sought is defined by the claims attached hereto.

1. A method for dynamic provisioning while roaming comprising:
receiving a roaming notification request from a roaming mobile computing device;
in response to said notification request, determining a possible roaming service profile;
sending said possible roaming service profile to said mobile computing device;
in response to said sending, receiving a reply indicating an acceptance or a refusal of said possible roaming service profile;
establishing a roaming service profile according to said possible roaming service profile if said reply indicates acceptance;
establishing a roaming service profile according to a default roaming service profile if said reply indicates refusal.

2. The method of claim 1 further comprising determining a plurality of possible roaming service profiles and sending said plurality of roaming service profiles to said mobile computing device.

3. The method of claim 1 wherein said sending is effected via a short message service (SMS) message.

4. The method of claim 1 wherein said reply is effected via a short message service (SMS) message.

5. The method of claim 1 wherein said method is performed by a roaming provisioning server.

6. The method of claim 1 wherein said roaming provisioning server is associated with a home carrier infrastructure respective to said mobile computing device.

7. The method of claim 1 wherein said roaming provisioning server is associated with a roaming carrier infrastructure associated with said roaming notification request.

8. The method of claim 1 wherein said determining further comprises determining a possible roaming billing profile in association with said possible roaming service profile and performing a remainder of said method using both said possible roaming billing profile and said possible roaming service profile.

9. The method of claim 8 further comprising receiving a default service profile associated with said mobile computing device and wherein said determining further comprises determining said possible roaming service profile to comprise a service profile that equals or surpasses said default service profile.

10. The method of claim 9 wherein said determining further comprises determining a possible roaming billing profile that has a fmancial charge that is less than a default billing profile associated with said mobile computing device.

11. The method of claim 10 further comprising receiving a default service profile associated with a roaming carrier infrastructure associated with said roaming notification request and wherein said determining further comprises determining said possible roaming service profile to comprise a service profile that is consistent with a service resource capability of said roaming carrier infrastructure.

12. The method of claim 11 wherein said determining further comprises determine said possible roaming billing profile that has a financial charge that is more than a financial charge incurred by a home carrier infrastructure to permit said mobile computing device to access said roaming carrier infrastructure.

13. The method of claim 1 further comprising receiving a default service profile associated with said mobile computing device and wherein said determining further comprises determining said possible roaming service profile to comprise a service profile that equals or surpasses said default service profile.

14. The method of claim 1 further comprising receiving a default service profile associated with a roaming carrier infrastructure associated with said roaming notification request and wherein said determining further comprises determining said possible roaming service profile to comprise a service profile that is consistent with a service resource capability of said roaming carrier infrastructure.

15. The method of claim 2 wherein said sending is effected via a short message service (SMS) message.

16. The method of claim 15 wherein said reply is effected via a short message service (SMS) message.

17. The method of claim 16 wherein said method is performed by a roaming provisioning server.

18. The method of claim 17 wherein said roaming provisioning server is associated with a home carrier infrastructure respective to said mobile computing device.

19. The method of claim 17 wherein said roaming provisioning server is associated with a roaming carrier infrastructure associated with said roaming notification request.

20. The method of claim 19 wherein said determining further comprises determining a possible roaming billing profile in association with said possible roaming service profile and performing a remainder of said method using both said possible roaming billing profile and said possible roaming service profile.
